(19) United States
(12) Patent Application Publication
(10) Pub. No.: US 2008/0315457 A1
(43) Pub. Date: Dec. 25, 2008

(54) Joint in Fluid Device and Method of Manufacture

(75) Inventors: Takeshi Ueki, Haga-gun, Tochigi (JP); Shingo Ishige, Haga-gun (JP)

Correspondence Address: BABCOCK IP, PLLC, P.O.BOX 488, BRIDGMAN, MI, 49106, US

(73) Assignee: SHOWA CORPORATION, Gyoda-shi, Saitama (JP)

(21) Appl. No.: 11/947,910

(22) Filed: Nov. 30, 2007

(30) Foreign Application Priority Data
Jun. 19, 2007 (JP) 2007-161861

(51) Int. Cl. B29D 23/00; B29C 39/02; F16L 25/00

(52) U.S. Cl. 264/299; 285/332

(57) ABSTRACT

In a manufacturing method of a joint in a fluid device, in which the joint is provided with an attaching portion attached to a connection port of the fluid device and a hose installation portion to which one end of a hose is installed, and the hose installation portion is provided with an outer diameter bulge portion in an intermediate portion in a range to which the hose is installed, an outer surface of a leading end side portion including the bulge portion of the hose installation portion is formed by an annular outer mold.

### BACKGROUND OF THE INVENTION

1. Field of the Invention

The present invention relates to a joint in a fluid device and a method of manufacturing such joint.

2. Description of the Related Art

As a joint formed by a resin or the like in a fluid device such as a pump or the like, as described in FIGS. 6 and 7, there is a structure which is provided with an attaching portion 1 attached to a connection port of the fluid device, and a bent portion 3 bent at right angle between the attaching portion 1 and a hose installation portion 2 in the hose installation portion to which one end of a hose is installed. The hose installation portion 2 is provided with an outer diameter bulge portion 2A in an intermediate portion in a range to which the hose is installed, thereby intending to closely attach the hose to the hose installation portion 2.

As a manufacturing method of the joint mentioned above, as described in FIGS. 6 and 7, there is a method using an annular outer mold 4 forming an outer surface of the attaching portion 1, two upper and lower split molds 5A and 5B forming the hose installation portion 2 and the bent portion 3, an inner mold 6 forming a distribution path from the attaching portion 1 toward the bent portion 3, and an inner mold 7 forming a distribution path from the hose insertion portion 2 toward the bent portion 3. The joint is formed by filling a resin into the mold, drawing out the inner mold 6 and the inner mold 7 after cooling, next drawing out the outer mold 4, and detaching two split molds 5A and 5B.

However, in the conventional manufacturing method mentioned above, as shown in FIG. 8, since an outer surface of the entire portion of a joint including the bulge portion 2A of the hose installation portion 2 is formed by two split molds 5A and 5B, a parting line 8 burr is generated over the entire length range along an axial direction (a longitudinal direction) of a range to which the hose is installed in the hose installation portion 2. Accordingly, a gap caused by the parting line 8 burr is generated over the entire length range along the axial direction in the range to which the hose is installed, between a rubber hose and the hose installation portion 2, when fitting the rubber hose to the hose installation portion 2 there is a risk that an oil pressurized by a head pressure of the oil within the tank or the like leaks from the gap.

In the joint described in Japanese Utility Model Application Publication (JP-Y) No. 4-10476 (patent document 1), in order to prevent the bleeding of the oil mentioned above, the joint is structured by a joint main body molded by a glassless resin and forming a distribution path in an inner portion, and a flange member molded by a glass resin, welded to the joint main body and attached to the fluid device by a bolt or the like, and is structured such that the entire outer surface of the hose installation portion in the joint main body is formed by an annular outer mold. The outer mold is forcedly drawn off from the hose installation portion of the molded joint main body, and the burr of the parting line is not generated on the outer surface of the hose installation portion.

In the joint described in JP-Y No. 4-10476, in order to forcedly draw off the hose installation portion of the joint main body by a single outer mold, the joint main body is molded by the glassless resin, arid the flange member welded to the joint main body and attached to the fluid device by the bolt or the like is molded by the glass resin. Since it is necessary to use two kinds of materials and two molding steps, and a welding step is further provided, many man hours are required.

### SUMMARY OF THE INVENTION

An object of the present invention is to mold an entire portion of a joint by one molding step using a single material, without generating a parting line burr on an outer surface of a leading end side portion including a bulge portion of a hose installation portion, thereby preventing leaks.

The present invention relates to a manufacturing method of a joint in a fluid device, the joint comprising an attaching portion attached to a connection port of the fluid device and a hose installation portion to which one end of a hose is installed. The hose installation portion is provided with an outer diameter bulge portion in an intermediate portion in a range to which the hose is installed. An outer surface of a leading end side portion including the bulge portion of the hose installation portion is formed by an annular outer mold.

### BRIEF DESCRIPTION OF THE DRAWINGS

The present invention will be more fully understood from the detailed description given below and from the accompanying drawings which should not be taken to be a limitation on the invention, but are for explanation and understanding only.

FIG. 1 is a cross-sectional view showing a joint and hose interconnection;

FIG. 2 is a cross-sectional view showing a manufacturing mold of the joint;

FIG. 3 is a cross-sectional view along a line III-III in FIG. 2;

FIG. 4 is a schematic view showing a mold parting for a hose installation portion of the joint;

FIGS. 5A and 5B are schematic views sowing a straight bulge portion of the hose installation portion of the joint;

FIG. 6 is a cross-sectional view showing a manufacturing mold of a joint in accordance with a prior art;

FIG. 7 is a cross-sectional view along a line VII-VII in FIG. 6; and

FIG. 8 is a schematic view showing a mold parting for a hose installation portion of the joint in accordance with the prior art.

### DESCRIPTION OF THE PREFERRED EMBODIMENTS

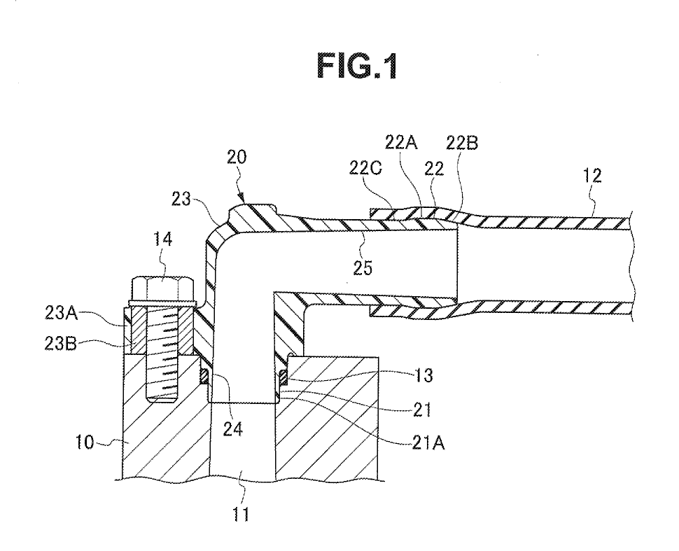

In FIG. 1, reference numeral 10 denotes a pump casing (a fluid device) such as a vane pump or the like. An intake port (a connection port) 11 is formed in the pump casing 10, a rubber hose 12 is connected to the intake port 11 via a joint 20, and an oil in a reservoir tank is supplied from the rubber hose 12.

The joint 20 is formed by a resin, and is provided with an attaching portion 21 attached to the intake port 11 of the pump casing 10, a hose installation portion 22 to which one end of the rubber hose 12 is installed, and a bent portion 23 bent at right angle between the attaching portion 21 and the hose installation portion 22.

The attaching portion 21 is provided with a tapered portion 21A inserted in a liquid tight manner to the intake port 11 of the pump casing 10 via an O-ring 13.

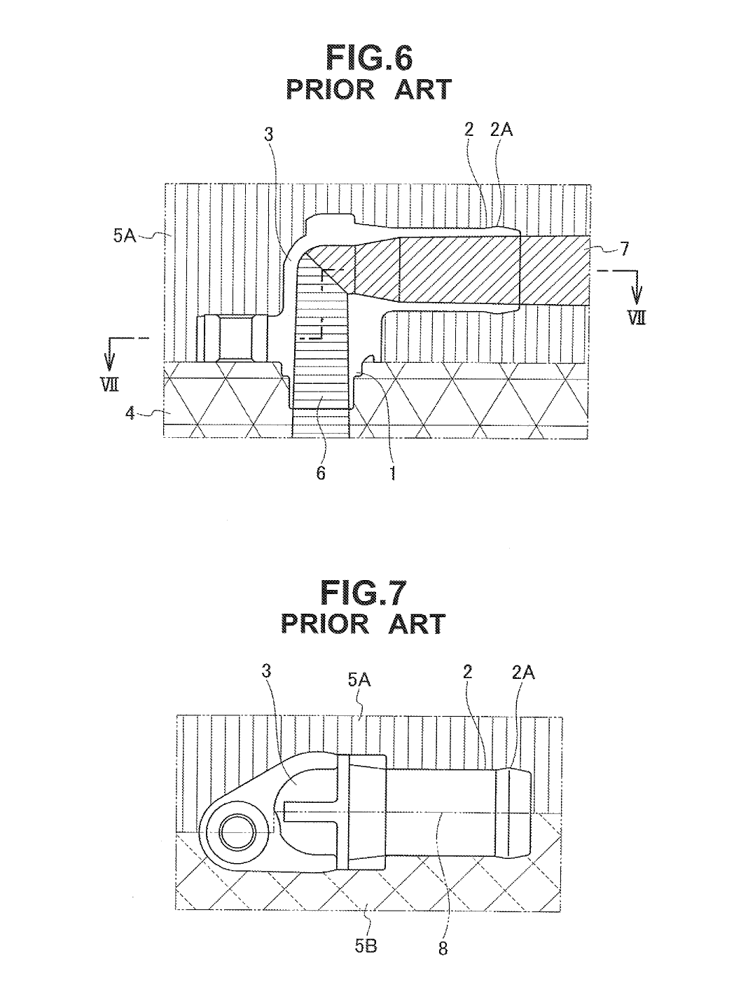

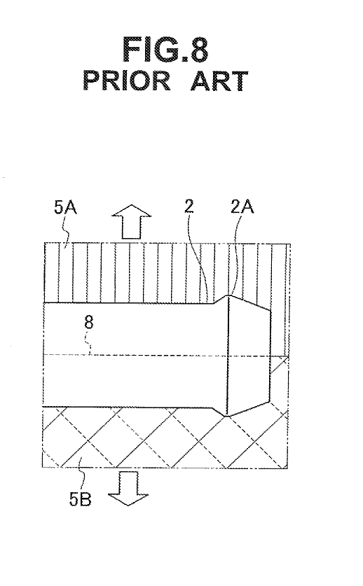

The hose installation portion 22 is provided with an expanded bulge portion 22A forming a maximum outer diameter in an intermediate portion in a range to which the rubber hose 12 is installed, and a tapered portion 22B in a leading end side thereof. In the present embodiment, the bulge portion 22A of the hose installation portion 22 is formed as a straight shape which has a uniform outer diameter and is continuous over a fixed length range L (FIG. 5A) in an axial direction. The rubber hose 12 is installed to an innermost side (an opposite leading end side) of the bulge portion 22A from the tapered portion 22B in the leading end side of the hose installation portion 22 via the bulge portion 22A, and is attached so as to form a close contact in the bulge portion 22A.

The bent portion 23 is molded in such a manner as to enwind a metal collar 23B to a boss 23A.

Accordingly, the joint 20 is used in such a manner as to fasten the boss 23A to the pump casing 10 and install the rubber hose 12 to the hose installation portion 22, by inserting the tapered portion 21A of the attaching portion 21 to the intake port 11 of the pump casing 10, and engaging the bolt 14 inserted to the collar 23B of the bent portion 23 with a thread hole of the pump casing 10.

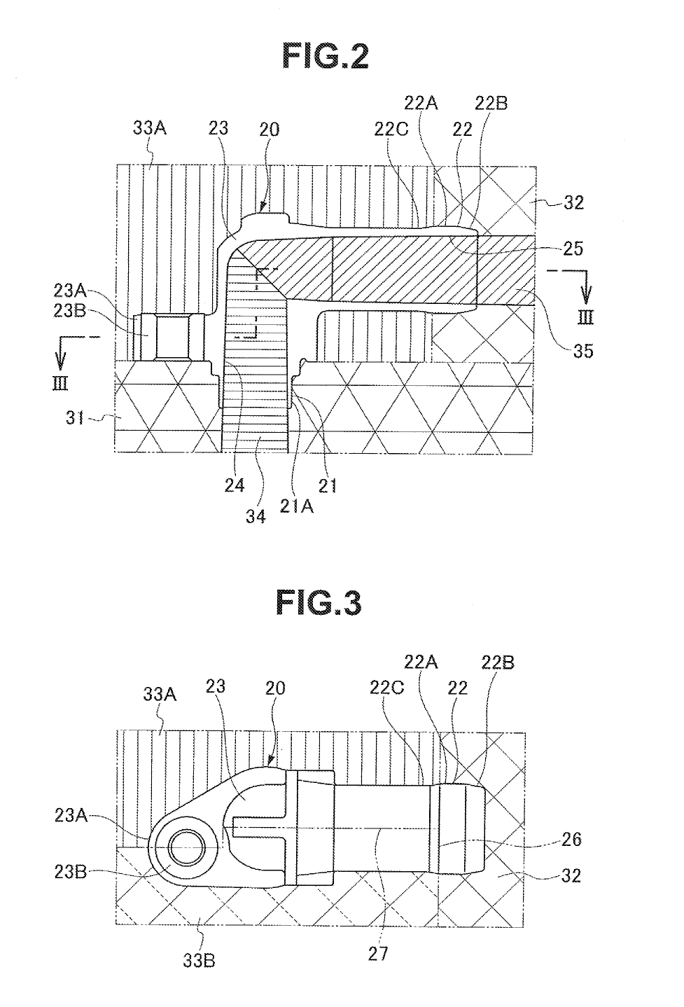

As shown in FIGS. 2 and 3, the joint 20 is formed in accordance with the following procedure by using six molds comprising an annular outer mold 31 forming an outer surface of the attaching portion 21, an annular outer mold 32 forming at least a part (preferably approximately the entire portion) of the bulge portion 22A of the hose installation portion 22, an outer surface of a leading end side portion (the bulge portion 22A and the tapered portion 22B) including the entire portion in the present embodiment, two upper and lower split molds 33A and 33B forming at least a part of the bulge portion 22A of the hose installation portion 22, an outer surface of an opposite leading end side portion (22C) which does not include the entire portion in the present embodiment, an inner mold 34 forming a distribution path 24 from the attaching portion 21 to the bent portion 23, and an inner mold 35 forming a distribution path 25 from the hose installation portion 22 to the bent portion 23. In this case, the outer mold 32 may form an outer surface of the leading end side portion (a part of the bulge portion 22A and the tapered portion 22B) including a part of the bulge portion 22A, in place of the entire portion of the bulge portion 22A of the hose installation portion 22.

Molding steps include:

(1) filling a resin into the molds 31 to 35.

(2) drawing off the inner mold 34 and the inner mold 35 after cooling the resin.

(3) drawing off the outer mold 31 and the outer mold 32, and detaching the upper and lower split molds 33A and 33B.

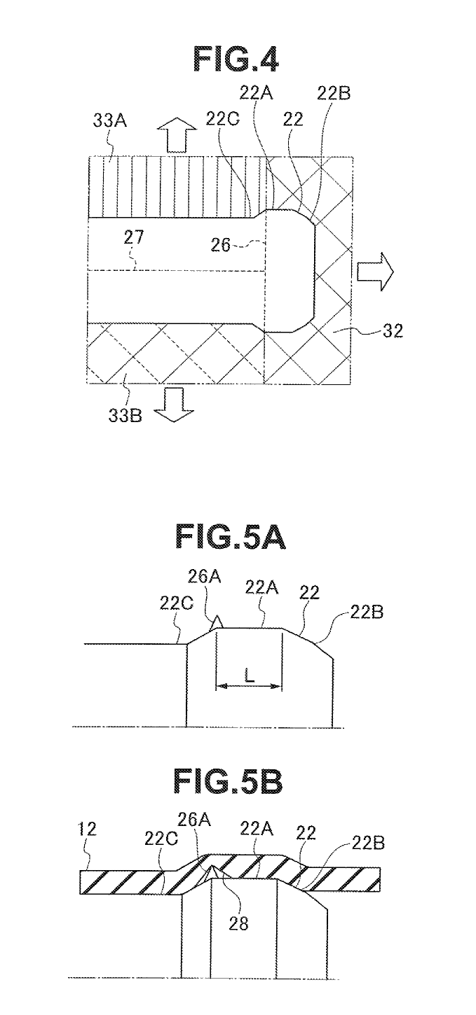

A burr along a parting line corresponding to a mating face of each of the molds is generated on an outer surface of the joint 20 formed by the molds 31, 32, 33A and 33B, as shown in FIG. 4. Since the outer mold 32 forming the outer surface of the leading end side portion (the bulge portion 22A and the tapered portion 22B) of the hose installation portion 22 of the joint 20 is not formed as a split mold, the burr along the parting line is not generated.

In accordance with the present embodiment, the following operations and effects are achieved.

(a) In the joint 20, the outer surface of the leading end side portion including the bulge portion 22A of the hose installation portion 22 (including at least a part of the bulge portion 22A) is formed by the annular outer mold 32. Accordingly, the entire portion of the joint 20 is formed by one molding step using a single material, the parting line does not exist in the leading end side portion including the bulge portion 22A in the range to which the hose 12 is installed in the hose installation portion 22, and the burr is not generated. Accordingly, the rubber hose 12 is closely attached to the leading end side portion including the bulge portion 22A of the hose installation portion 22 without generating the gap caused by the burr of the parting line, at a time of fitting the rubber hose 12 to the hose installation portion 22, whereby it is possible to prevent the oil pressurized by the head pressure or the like of the oil within the tank from leaking.

(b) When the joint portion 20 is formed in such a manner as to have the bent portion 23 between the attaching portion 21 and the hose installation portion 22, an outer surface of the opposite leading end side portion which does not include the bulge portion 22A of the hose installation portion 22 (which does not include at least a part of the bulge portion 22A) and an outer surface of the bent portion 23 are formed by two split molds 33A and 33B. At this time, an annular parting line 26 is generated in a boundary between the outer mold 32 mentioned above for the leading end side portion including the bulge portion 22A of the hose installation portion 22, and each of two split molds 33A and 33B, and a linear parting line 27 is generated in a boundary between two split molds 33A and 33B. Further, burrs 26A and 27A of the annular parting line 26 and the linear parting line 27 mentioned above are generated on an outer surface of the joint 20 (FIGS. 4 to 5B). Accordingly, at a time of fitting the rubber hose 12 to the hose installation portion 22, the rubber hose 12 generates a gap 28 caused by the burrs 26A and 27A of the parting lines 26 and 27 with respect to the opposite leading end side portion which does not include the bulge portion 22A in the hose installation portion 22. However, since the rubber hose 12 is closely attached to the leading end side portion including the bulge portion 22A of the hose installation portion 22 without generating the gap caused by the burr of the parting line for the reason of the item (a) mentioned above, it is possible to prevent the oil pressurized by the head pressure or the like of the oil within the tank from leaking (FIGS. 5A and 5B).

(c) The bulge portion 22A of the hose installation portion 22 of the joint 20 is formed as a straight shape which is continuous over the fixed length range in the axial direction at the uniform outer diameter. Accordingly, even if the rubber hose 12 generates the gap 28 caused by the burrs 26A and 27A of the parting lines 26 and 27 (particularly, the annular parting line 26) in the item (b) mentioned above in the opposite leading end side portion of the hose installation portion 22, at a time of fitting the rubber hose 12 to the hose installation portion 22, the gap can 28 be securely sealed with respect to the external filed by the rubber hose 12 which is closely attached over the fixed length range of the bulge portion 22A formed as the straight shape in the leading end side portion of the hose installation portion 22.

In this case, as shown in FIGS. 5A and 5B, the gap 28 can be sealed at the length of 4 mm of the straight portion of the bulge portion 22A, with respect to the burr 26 having a height of 0.1 mm.

As heretofore explained, embodiments of the present invention have been described in detail with reference to the drawings. However, the specific configurations of the present invention are not limited to the embodiments but those having a modification of the design within the range of the present invention are also included in the present invention. For example, the joint in accordance with the present invention may be provided, with no bent portion, as far as the joint is provided with at least the attaching portion and the hose installation portion.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be embodied within a scope encompassed and equivalents thereof with respect to the features set out in the appended claims.

What is claimed is:

1. A manufacturing method of a joint in a fluid device, the joint comprising an attaching portion attached to a connection port of the fluid device and a hose installation portion to which one end of a hose is installed, and
the hose installation portion being provided with an outer diameter bulge portion in an intermediate portion in a range to which the hose is installed,
wherein an outer surface of a leading end side portion including the bulge portion of the hose installation portion is formed by an annular outer mold.

2. A manufacturing method of a joint in a fluid device according to claim 1, wherein the joint is formed so as to have a bent portion between the attaching portion and the hose installation portion,
an outer surface of an opposite leading end side portion which does not include the bulge portion of the hose installation portion and an outer surface of the bent portion are formed by two split molds.

3. A manufacturing method of a joint in a fluid device according to claim 1, wherein the bulge portion of the hose installation portion is formed as a straight shape which has a uniform outer diameter and is continuous over a fixed length range in an axial direction.

4. A manufacturing method of a joint in a fluid device according to claim 2, wherein the bulge portion of the hose installation portion is formed as a straight shape which has a uniform outer diameter and is continuous over a fixed length range in an axial direction.

5. A manufacturing method of a joint in a fluid device according to claim 1, wherein the hose installation portion is provided with an expanded bulge portion forming a maximum outer diameter in an intermediate portion of the range to which the hose is installed, and a tapered portion in a leading end side thereof.

6. A manufacturing method of a joint in a fluid device according to claim 2, wherein the hose installation portion is provided with an expanded bulge portion forming a maximum outer diameter in an intermediate portion of the range to which the hose is installed, and a tapered portion in a leading end side thereof.

7. A manufacturing method of a joint in a fluid device according to claim 5, wherein a part of the bulge portion of the hose installation portion and an outer surface of the tapered portion are formed by an outer mold.

8. A manufacturing method of a joint in a fluid device according to claim 6, wherein a part of the bulge portion of the hose installation portion and an outer surface of the tapered portion are formed by an outer mold.

9. A joint of a fluid device manufactured by the manufacturing method of the joint in the fluid device according to claim 1.

10. A joint of a fluid device manufactured by the manufacturing method of the joint in the fluid device according to claim 2.

11. A joint of a fluid device manufactured by the manufacturing method of the joint in the fluid device according to claim 3.

12. A joint of a fluid device manufactured by the manufacturing method of the joint in the fluid device according to claim 4.

13. A joint of a fluid device manufactured by the manufacturing method of the joint in the fluid device according to claim 5.

14. A joint of a fluid device manufactured by the manufacturing method of the joint in the fluid device according to claim 6.

15. A joint of a fluid device manufactured by the manufacturing method of the joint in the fluid device according to claim 7.

16. A joint of a fluid device manufactured by the manufacturing method of the joint in the fluid device according to claim 8.
